(19) United States
(12) Patent Application Publication
(10) Pub. No.: US 2024/0372066 A1
(43) Pub. Date: Nov. 7, 2024

(54) Electrode Plate and Battery Having the Same

(71) Applicant: JIANGSU ZENERGY BATTERY TECHNOLOGIES CO., LTD., Jiangsu (CN)

(72) Inventors: Bingyang HUA, Jiangsu (CN); Wuyuan ZOU, Jiangsu (CN)

(21) Appl. No.: 18/288,176

(22) PCT Filed: May 7, 2022
(86) PCT No.: PCT/CN2022/091503

§ 371 Date: Oct. 24, 2023

(30) Foreign Application Priority Data
May 8, 2021 (CN) 202110497937.4

(51) Int. Cl. H01M 4/131; H01M 4/02; H01M 4/66; H01M 10/0525

(52) U.S. Cl. CPC H01M 4/131; H01M 4/661; H01M 10/0525; H01M 2004/021; H01M 2004/028

(57) ABSTRACT

Disclosed are an electrode plate and a battery having the same. The electrode plate includes a current collector, a first coating and a second coating, the first coating is coated on at least one surface of the current collector, the second coating is coated on a surface of the first coating away from the current collector, and an Ol value of the second coating is less than an Ol value of the first coating. Compared with the related art, the electrode plate of the disclosure divides a thick coating layer into the first coating and the second coating for separate coating in order to ensure an energy density of the battery, and then the Ol value of the second coating is set to be less than that of the first coating. Therefore, an entire Ol value of the electrode plate is low.

### CROSS-REFERENCE TO RELATED APPLICATION

The disclosure is a National Stage Filing of the PCT International Application No: PCT/CN2022/091503 filed on 7 May 2022, which claims priority to and the benefit of Chinese Patent Application No. 202110497937.4, filed to the China National Intellectual Property Administration (CHIPA) on 8 May 2021, which is hereby incorporated by reference in its entirety.

### Technical Field

The disclosure relates to the technical field of lithium batteries, and in particular to an electrode plate and a battery having the same.

### BACKGROUND

A lithium ion battery, a type of novel energy, has been applied to electronic products and electric vehicles in a wide range because of its high energy density, large capability, long cycle life, no memory effect, etc. With science and technology advancing, various electronic products impose rising requirements on battery energy density, and accordingly, a coating weight and a coating thickness designed for an electrode plate keep increasing. In consequence, a charge transfer path becomes longer, a charge and discharge rate capability of a battery is reduced, a cycle life of the battery is shortened, and safety of the battery is reduced.

In view of that, a technical solution to solve the above problems has to be provided.

### SUMMARY

The disclosure aims to provide an electrode plate, so as to solve the problem that since a coating weight and a coating thickness designed for an electrode plate keep increasing, a charge transfer path becomes longer. Accordingly, a charge rate capability of a battery is improved, a cycle life of the battery is prolonged, and safety of the battery is improved.

In order to achieve the above object, the disclosure adopts the technical solution as follows:

Some embodiments of the disclosure provide an electrode plate, including:
a current collector;
a first coating, the first coating is coated on at least one surface of the current collector; and
a second coating, the second coating is coated on a surface of the first coating away from the current collector;
an Ol value of the second coating is less than an Ol value of the first coating.

In some embodiments, the Ol value of the first coating represented by Ol₁ and the Ol value of the second coating represented by Ol₂ satisfy a relational expression: 1.1≤Ol₁/Ol₂≤2.0. Specifically, relational expressions that Ol₁ and Ol₂ satisfy include, but are not limited to, 1.1≤Ol₁/Ol₂<1.3, 1.3≤Ol₁/Ol₂<1.5, 1.5≤Ol₁/Ol₂<1.8, or 1.8≤Ol₁/Ol₂≤2.0. A ratio of the Ol values of the two coatings is set within such a range, in one aspect, a dynamic performance of the second coating is able to be significantly improved, and therefore a power performance, a charge rate capability and a cycle capability of a battery is improved; in another aspect, a great difference in lithium intercalation capability between the first coating and the second coating is avoided, so that a consistency of the electrode plate is ensured, and severe lithium plating during charge and poor cycle performance of a cell caused by local deterioration of the electrode plate are avoided.

In some embodiments, the Ol value of the first coating represented by Ol₁ is 5-10, 10-20, 20-30, 30-40, 40-50, 50-60, 60-70, or 70-80; and the Ol value of the second coating represented by Ol2 is 3-10, 10-15, 15-20, 20-25, 25-30, 30-35, or 35-40. The Ol values of the first coating and the second coating should be specifically set in such a way that the Ol value of the second coating is less than that of the first coating all the time. In addition, since a positive electrode plate and a negative electrode plate have different active materials, the Ol values of the two coatings are also set differently. It is found from a vast number of experimental studies that by setting an Ol value of the negative electrode plate to be less than that of the positive electrode plate, battery performance is improved.

In some embodiments, an Ol value of an active material in the first coating is 2.5-5, 5-10, 10-15, or 15-20; and an Ol value of an active material in the second coating is 2-5, 5-10, 10-12, or 12-15. Corresponding to the foregoing, the Ol value of the active material in the second coating should be less than that of the active material in the first coating. In this way, by regulating the Ol value of the active material, it is conducive to regulating the Ol value of the coating, and then more conducive to regulating an Ol value of the electrode plate. The Ol value of the active material is closely related to physical and chemical properties such as a particle size of particles and resistance of powder. The Ol value is able to be changed by adjusting the physical and chemical properties. Certainly, except for adjusting the Ol value of the active material, the Ol value of the coating is also able to be adjusted by adjusting a proportion of a conductive agent, etc. As long as the Ol value of the second coating is less than that of the first coating, the battery performance is able to be improved. More specifically, by setting the ratio of the Ol values of the two coatings within the above range, the rate charge capability of the battery is able to be further improved.

In some embodiments, the resistance of an active material in the first coating is 1Ω-5Ω, 5Ω-10Ω, 10Ω15Ω, 15Ω20Ω, or 25Ω30Ω; and the resistance of an active material in the second coating is 0.30Ω-1Ω, 1Ω-2Ω, 2Ω-3Ω, 3Ω-4Ω, 4Ω-5Ω, 5Ω-6Ω, 6Ω-7Ω, 7Ω-8Ω, 8Ω-9Ω, or 90Ω-10Ω. Generally, the smaller the resistance of the active material is, the shorter the lithium ion transport path is. The smaller the Ol value of the active material is, the smaller the Ol value of the coating is. Under a condition that the electrode plate has the same compaction density and coating density, the smaller the Ol value of the coating is, the smaller the Ol value of the electrode plate is. Accordingly, the charge rate capability is improved, and the cycle performance is optimized.

In some embodiments, an average particle diameter D50 of an active material in the first coating is 2 μm-5 μm, 5 μm-10 μm, 10 μm-15 μm, 15 μm-20 μm, 20 μm-25 μm, or 25 μm-30 μm; and an average particle diameter D50 of an active material in the second coating is 1 μm-5 μm, 5 μm-10 μm, 10 μm-12 μm, 12 μm-15 μm, 15 μm-18 μm, or 18 μm-20 μm.

Generally, the smaller the D50 of the active material is, the smaller the resistance of the active material is, and the shorter the lithium ion transport path is. The smaller the Ol value of the active material is, the smaller the Ol value of the coating is, and the smaller the Ol value of the electrode plate is. Therefore, a particle size of the active material is able to be screened corresponding to the resistance thereof. In this way, the Ol value of the coating is able to be specifically designed at any time according to the actual situation, so as to achieve the purpose that the Ol values of the electrode plate obtained by the first coating and the second coating are not consistent.

In some embodiments, the specific surface area of an active material in the first coating is 0.2 m²/g-0.5 m²/g, 0.5 m²/g-0.8 m²/g, 0.8 m²/g-1.0 m²/g, 1.0 m²/g-1.2 m²/g, 1.2 m²/g-1.5 m²/g, 1.5 m²/g-1.5 m²/g, or 1.5 m²/g-2.0 m²/g; and the specific surface area of an active material in the second coating is 0.5 m²/g-0.8 m²/g, 0.8 m²/g-1.0 m²/g, 1.0 m²/g-1.2 m²/g, 1.2 m²/g-1.5 m²/g, 1.5 m²/g-1.8 m²/g, 1.5 m²/g-2.0 m²/g, 2.0 m²/g-2.5 m²/g, or 2.5 m²/g-3.0 m²/g. The smaller the D50 of the active material is, the larger the specific surface area is, the smaller the resistance of the obtained electrode plate is, the shorter the lithium ion transport path is, and the smaller the Ol value of the electrode plate is. Accordingly, the charge rate capability is improved, and the cycle performance is optimized.

In some embodiments, the thickness of the second coating is less than the thickness of the first coating. The thickness of the first coating is a conventional thickness, and the thickness of the second coating is an optimized thickness. By setting the thickness of the second coating to be less than that of the first coating, the lithium ion transport path becomes shorter. Therefore, the Ol value of the electrode plate is reduced, the charge rate capability is further improved, and the cycle performance is further optimized.

In some embodiments, the thickness of the first coating represented by H₁ and the thickness of the second coating represented by H₂ satisfy a relational expression: 1<H₁/H₂<10. When the second coating has a lower thickness ratio, the Ol value of the electrode plate is not able to be optimized, and an expected effect is not able to be achieved. When the second coating has a higher thickness ratio, a coating cost will be high, and an entire thickness of the electrode plate will also be increased, so that the problem that the charge transfer path becomes longer is not able to be solved.

In some embodiments, the H₁ is 50 μm-80 μm, 80 μm-120 μm, 120 μm-150 μm, 150 μm-200 μm, 200 μm-250 μm, or 250 μm-300 μm; and the H₂ is 10 μm-30 μm, 30 μm-50 μm, 50 μm-100 μm, 100 μm-130 μm, 130 μm-160 μm, or 160 μm-200 μm.

Some other embodiments of the disclosure provide a battery, including a positive electrode plate, a negative electrode plate, and a separator spacing the positive electrode plate and the negative electrode plate apart, and the positive electrode plate and the negative electrode plate are the above electrode plate; or the positive electrode plate or the negative electrode plate is the above electrode plate.

Compared with the related art, the disclosure has the beneficial effects as follows:
1) The electrode plate of the disclosure divides a relatively thick coating layer into the first coating and the second coating for separate coating in order to ensure an energy density of the battery. Then, the Ol value of the second coating is set to be less than that of the first coating by regulating the Ol values of the first coating and the second coating. Therefore, the entire Ol value of the electrode plate is relatively low. Moreover, since the second coating has desirable dynamic performance and liquid retention and absorption capabilities, the charge rate capability is improved, the cycle life of the battery is prolonged, and the safety of the battery is improved.
2) In addition, in the electrode plate provided by the disclosure, the ratio of the Ol values of the first coating and the second coating is further provided. Therefore, the poor consistency of the electrode plate caused by a great difference in lithium intercalation capability between the two coatings is also able to be avoided while the charge rate performance of the battery is improved.

### DETAILED DESCRIPTION OF THE EMBODIMENTS

1. An electrode plate includes: a current collector, a first coating, and a second coating, the first coating is coated on at least one surface of the current collector, the second coating is coated on a surface of the first coating away from the current collector, and an Ol value of the second coating is less than an Ol of the first coating. When the electrode plate is a positive electrode plate, Ol=C₀₀₃/C₁₁₀, wherein Coos represents the characteristic diffraction peak area of 003 crystal plane in X-ray diffraction pattern of the coating of the positive electrode plate, and Cho represents the characteristic diffraction peak area of 110 crystal plane in X-ray diffraction pattern of the coating of the positive electrode plate; when the electrode plate is a negative electrode plate, Ol=C₀₀₄/C₁₁₀, wherein C₀₀₄ represents the characteristic diffraction peak area of 004 crystal plane in X-ray diffraction pattern of the coating of the negative electrode plate, and C₁₁₀ represents the characteristic diffraction peak area of 110 crystal plane in X-ray diffraction pattern of the coating of the negative electrode plate.

In some embodiments, the Ol value of the first coating represented by Ol₁ and the Ol value of the second coating represented by Ol₂ satisfy a relational expression: 1.1≤Ol₁/Ol₂≤2.0. Specifically, relational expressions that Ol₁ and Ol₂ satisfy include, but are not limited to, 1.1≤Ol₁/Ol₂<1.3, 1.3≤Ol₁/Ol₂<1.5, 1.5≤O₁/Ol₂<1.8, or 1.8≤Ol₁/Ol₂≤2.0. A ratio of the Ol values of the two coatings is set within such a range. In one aspect, dynamic performance of the second coating is able to be significantly improved, and therefore a power performance, a charge rate capability, and a cycle capability of a battery are improved. In another aspect, a great difference in lithium intercalation capability between the first coating and the second coating is avoided, so that a consistency of the electrode plate is ensured, and severe lithium plating during charge and poor cycle performance of a cell caused by local deterioration of the electrode plate are avoided.

In some embodiments, the Ol value of the first coating represented by Oli is 5-10, 10-20, 20-30, 30-40, 40-50, 50-60, 60-70, or 70-80; and the Ol value of the second coating represented by Ol₂ is 3-10, 10-15, 15-20, 20-25, 25-30, 30-35, or 35-40. The Ol values of the first coating and the second coating should be specifically set in such a way that the Ol value of the second coating is less than that of the first coating all the time. In addition, since a positive electrode plate and a negative electrode plate have different active materials, the Ol values of the two coatings are also set differently. It is found from a vast number of experimental studies that by setting an Ol value of the negative electrode plate to be less than that of the positive electrode plate, battery performance is improved.

In some embodiments, an Ol value of an active material in the first coating is 2.5-5, 5-10, 10-15, or 15-20; and an Ol value of an active material in the second coating is 2-5, 5-10, 10-12, or 12-15. Corresponding to the foregoing, the Ol value of the active material in the second coating should be less than that of the active material in the first coating. In this way, by regulating the Ol value of the active material, it is conducive to regulating the Ol value of the coating, and then more conducive to regulating an Ol value of the electrode plate. The Ol value of the active material is closely related to physical and chemical properties such as a particle size of particles and resistance of powder. The Ol value is able to be changed by adjusting the physical and chemical properties. Certainly, except for adjusting the Ol value of the active material, the Ol value of the coating is also able to be adjusted by adjusting a proportion of a conductive agent, etc. As long as the Ol value of the second coating is less than that of the first coating, the battery performance is able t be improved. More specifically, by setting the ratio of the Ol values of the two coatings within the above range, the rate charge capability of the battery is able to be further improved.

In some embodiments, the resistance of the active material in the first coating is 1Ω-5Ω,5Ω-10Ω, 10Ω-15Ω, 15Ω-20Ω, 20Ω-25Ω, or 25Ω-30Ω; and the resistance of the active material in the second coating is 0.3Ω-1Ω, 1Ω-2Ω, 2Ω-3Ω, 3Ω-4Ω, 4Ω-5Ω, 5Ω-6Ω, 6Ω-7Ω, 7Ω-8Ω, 8Ω-9Ω, or 9Ω-10Ω. Generally, the smaller the resistance of the active material is, the shorter the lithium ion transport path is. The smaller the Ol value of the active material is, the smaller the Ol value of the coating is. Under a condition that the electrode plate has the same compaction density and coating density, the smaller the Ol value of the coating is, the smaller the Ol value of the electrode plate is. Accordingly, the charge rate capability is improved, and the cycle performance is optimized.

In some embodiments, an average particle diameter D50 of the active material in the first coating is 2 μm-5 μm, 5 μm-10 μm, 10 μm-15 μm, 15 μm-20 μm, 20 μm-25 μm, or 25 μm-30 μm; and an average particle diameter D50 of the active material in the second coating is 1 μm-5 μm, 5 μm-10 μm, 10 μm-12 μm, 12 μm-15 μm, 15 μm-18 μm, or 18 μm-20μm.

Generally, the smaller the D50 of the active material is, the smaller the resistance of the active material is, and the shorter the lithium ion transport path is. The smaller the Ol value of the active material is, the smaller the Ol value of the coating is, and the smaller the Ol value of the electrode plate is. Therefore, a particle size of the active material is able to be screened corresponding to the resistance thereof. In this way, the Ol of the coating is able to be specifically designed at any time according to the actual situation, so as to achieve the purpose that the Ol values of the electrode plate obtained by the first coating and the second coating are not consistent.

In some embodiments, the specific surface area of an active material in the first coating is 0.2 m²/g-0.5 m²/g, 0.5 m²/g-0.8 m²/g, 0.8 m²/g-1.0 m²/g, 1.0 m²/g-1.2 m²/g, 1.2 m²/g-1.5 m²/g, 1.5 m²/g-1.5 m²/g, or 1.5 m²/g-2.0 m²/g; and the specific surface area of the active material in the second coating is 0.5 m²/g-0.8 m²/g, 0.8 m²/g-1.0 m²/g, 1.0 m²/g-1.2 m²/g, 1.2 m²/g-1.5 m²/g, 1.5 m²/g-1.8 m²/g, 1.5 m²/g-2.0 m²/g, 2.0 m²/g-2.5 m²/g, or 2.5 m²/g-3.0 m²/g. The smaller the D50 of the active material is, the larger the specific surface area is, the smaller the resistance of the obtained electrode plate is, the shorter the lithium ion transport path is, and the smaller the Ol value of the electrode plate is. Accordingly, the charge rate capability is improved, and the cycle performance is optimized.

In some embodiments, the thickness of the second coating is less than the thickness of the first coating. The thickness of the first coating is a conventional thickness, and the thickness of the second coating is an optimized thickness. By setting the thickness of the second coating to be less than that of the first coating, the lithium ion transport path becomes shorter. Therefore, the Ol value of the electrode plate is reduced, the charge rate capability is further improved, and the cycle performance is further optimized.

In some embodiments, the thickness of the first coating represented by H₁ and the thickness of the second coating represented by H2 satisfy a relational expression: 1<H₁/H₂<10. When the second coating has a lower thickness ratio, the Ol value of the electrode plate is not able to be optimized, and an expected effect is not able to be achieved. When the second coating has a higher thickness ratio, a coating cost will be high, and an entire thickness of the electrode plate will also be increased, so that the problem that the charge transfer path becomes longer is not able to be solved.

In some embodiments, the H₁ is 50 μm-80 μm, 80 μm-120 μm, 120 μm-150 μm, 150 μm-200 μm, 200 μm-250 μm, or 250 μm-300 μm; and the H₂ is 10 μm-30 μm, 30 μm-50 μm, 50 μm-100 μm, 100 μm-130 μm, 130 μm-160 μm, or 160 μm-200 μm.

2. A battery includes a positive electrode plate, a negative electrode plate, and a separator spacing the positive electrode plate and the negative electrode plate apart, and the positive electrode plate and the negative electrode plate are the above electrode plate; or the positive electrode plate or the negative electrode plate is the above electrode plate.

An active material of the first coating and the second coating coated on the current collector of the positive electrode plate includes, but is not limited to, one or a combination of compounds represented by a chemical formula such as LiₐNiₓCo_{y}M_{z}O_{2-b}N_{b} (wherein 0.95≤a≤1.2, x>0, y≥0, z>0, x+y+z=1, 0≤b≤1, M is selected from one or a combination of Mn and Al, and N is selected from one or a combination of F, P and S). A positive active material further includes, but is not limited to, one or a combination of LiCoO₂, LiNiO₂, LiVO₂, LiCrO₂, LiMn₂O₄, LiCoMnO₄, Li₂NiMn₃O₈, LiNi_{0.5}Mn_{1.5}O₄, LiCoPO₄, LiMnPO₄, LiFePO₄, LiNiPO₄, LiCoFSO₄, CuS₂, FeS₂, MoS₂, NiS, and TiS₂. The positive active material is also able to be subjected to modification treatment. Methods for modifying the positive active material should be known to those skilled in the art. For example, the positive active material is modified through coating, doping, etc. A material used for modification treatment includes, but is not limited to, one or a combination of AI, B, P, Zr, Si, Ti, Ge, Sn, Mg, Ce, W, etc. The positive current collector is typically a structure or part for collecting a current and is any material suitable for being used as the positive current collector of a lithium ion battery in the art. For example, the positive current collector includes, but is not limited to, metal foil, etc. More specifically, the positive current collector includes, but is not limited to, aluminum foil, etc.

An active material of the first coating and the second coating coated on the current collector of the negative electrode plate includes, but is not limited to, one or more of graphite, soft carbon, hard carbon, carbon fiber, a mesocarbon microbeads, a silicon-based material, a tin-based material, lithium titanate, or other metal capable of forming alloy with lithium. The graphite is selected from one or more of artificial graphite, natural graphite, and modified graphite. The silicon-based material is selected from one or more of monatomic silicon, a silicon-oxygen compound, a silicon-carbon complex, and silicon alloy. The tin-based material is selected from one or more of monatomic tin, a tin-oxygen compound, and tin alloy. The negative current collector is typically a structure or part for collecting a current and is any material suitable for being used as the negative current collector of the lithium ion battery in the art. For example, the negative current collector includes, but is not limited to, metal foil, etc. More specifically, the negative current collector includes, but is not limited to, copper foil, etc.

The separator is any material suitable for being used as the separator of the lithium ion battery in the art. For example, the separator is made of one or a combination of materials including, but not limited to, polyethylene, polypropylene, polyvinylidene fluoride, aramid, polyethylene terephthalate, polytetrafluoroethylene, polyacrylonitrile, polyimide, polyamide, polyester, natural fiber, etc.

The battery further includes an electrolyte. The electrolyte includes an organic solvent, electrolyte lithium salt, and an additive. The electrolyte lithium salt is LiPF₆ and/or LiBOB used in a high-temperature electrolyte, at least one of LiBF₄, LiBOB, and LiPF₆ used in a low-temperature electrolyte, at least one of LiBF₄, LiBOB, LiPF₆, and LiTFSI used in an overcharge-proof electrolyte, or at least one of LiCICO₄, LiAsF₆, LiCF₃SO₃, and LiN(CF₃SO₂)₂. The organic solvent is a cyclic carbonate such as propylene carbonate (PC) and ethylene carbonate (EC), a chain carbonate such as diethyl carbonate (DEC), dimethyl carbonate (DMC), or ethyl methyl carbonate (EMC), or a carboxylic ester such as methyl formate (MF), methyl acetate (MA), ethyl acetate (EA), methyl propionate (MP), etc. The additive includes, but is not limited to, at least one of a film-forming additive, a conductive additive, a flame retardant additive, an overcharge-proof additive, an additive for controlling contents of H₂O and hydrogen fluoride (HF) in the electrolyte, an additive for improving low-temperature performance, and a multifunctional additive.

In order to make the technical solutions and advantages of the disclosure clearer, the disclosure and the beneficial effects of the disclosure will be further described in detail below in combination with particular embodiments, but the embodiments of the disclosure are not limited thereto.

### Example 1

A battery includes a positive electrode plate, a negative electrode plate, a separator spaced between the positive electrode plate and the negative electrode plate, and an electrolyte. The positive electrode plate adopts ternary NCM523 as the active material and includes aluminum foil, a first coating, and a second coating. The first coating is coated on a surface of the aluminum foil. The second coating is coated on a surface of the first coating away from the aluminum foil. Ol₁/Ol₂ of the first coating and the second coating equals 1.25, H₁=200 μm, and H₂=50 μm. The negative electrode plate adopts the conventional graphite as the active material and is provided with no first coating or second coating. A coating of the negative electrode plate has a total thickness of 250 μm. The separator is made of polyethylene. Then, the positive electrode plate, the separator, and the negative electrode plate are made into a cell, and the electrolyte is injected to assemble a lithium ion battery. The electrolyte includes the organic solvent, the electrolyte lithium salt, and the additive. The organic solvent is PC, the electrolyte lithium salt is LiBF₄, and the additive is the film-forming additive.

### Examples 2-10

A ratio of Ol₁/Ol₂ of the positive electrode plate is different from that in Example 1 and is specifically shown in Table 1 as follows.

The rest are the same as those in Example 1, which will not be repeated herein.

### Example 11

A battery includes a positive electrode plate, a negative electrode plate, a separator spaced between the positive electrode plate and the negative electrode plate, and an electrolyte. The negative electrode plate adopts the graphite as the active material and includes copper foil, a first coating, and a second coating. The first coating is coated on a surface of the copper foil. The second coating is coated on a surface of the first coating away from the copper foil. Ol₁/Ol₂ of the first coating and the second coating equals 1.17, H₁=200 μm, and H₂=50 μm. The positive electrode plate adopts conventional ternary NCM523 as the active material and is provided with no first coating or second coating. A coating of the positive electrode plate has a total thickness of 250 μm. The separator is made of polyethylene. Then, the positive electrode plate, the separator, and the negative electrode plate are made into a cell, and the electrolyte is injected to assemble a lithium ion battery. The electrolyte includes the organic solvent, the electrolyte lithium salt, and the additive. The organic solvent is PC, the electrolyte lithium salt is LiBF₄, and the additive is the film-forming additive.

### Examples 12-20

A ratio of Ol₁/Ol₂ of the negative electrode plate is different from that in Example 11 and is specifically shown in Table 1 as follows.

The rest are the same as those in Example 11, which will not be repeated herein.

### Example 21

A battery includes a positive electrode plate, a negative electrode plate, a separator spaced between the positive electrode plate and the negative electrode plate, and an electrolyte. The positive electrode plate adopts ternary NCM523 as the active material and includes aluminum foil, a first coating, and a second coating. The first coating is coated on a surface of the aluminum foil. The second coating is coated on a surface of the first coating away from the aluminum foil. Ol₁/Ol₂ of the first coating and the second coating equals 1.11, H1=200 μm, and H2=50um. The negative electrode plate adopts the graphite as the active material and includes copper foil, a first coating, and a second coating. The first coating is coated on a surface of the copper foil. The second coating is coated on a surface of the first coating away from the copper foil. Ol1/Ol2 of the first coating and the second coating equals 1.20, H₁=200 μm, and H₂=50 μm. The separator is made of polyethylene. Then, the positive electrode plate, the separator, and the negative electrode plate are made into a cell, and the electrolyte is injected to assemble a lithium ion battery. The electrolyte includes the organic solvent, the electrolyte lithium salt, and the additive. The organic solvent is PC, the electrolyte lithium salt is LiBF₄, and the additive is the film-forming additive.

### Examples 22-30

A ratio of Ol₁/Ol₂ of the positive electrode plate and the negative electrode plate is different from that in Example 21 and is specifically shown in Table 1 as follows.

The rest are the same as those in Example 21, which will not be repeated herein.

### Comparative Example 1

A battery includes a positive electrode plate, a negative electrode plate, a separator spaced between the positive electrode plate and the negative electrode plate, and an electrolyte. The positive electrode plate adopts conventional ternary NCM523 as the active material. The negative electrode plate adopts conventional graphite as the active material. The positive electrode plate and the negative electrode plate are provided with no first coating or second coating and have a total coating thickness of 250 μm. An Ol value of the positive electrode plate is 43.2, and an Ol value of the negative electrode plate is 8.7. The separator is made of polyethylene. Then, the positive electrode plate, the separator, and the negative electrode plate are made into a cell, and the electrolyte is injected to assemble a lithium ion battery. The electrolyte includes the organic solvent, the electrolyte lithium salt, and the additive. The organic solvent is PC, the electrolyte lithium salt is LiBF4, and the additive is the film-forming additive.

### Comparative Examples 2-3

Ol values of the positive electrode plate and the negative electrode plate are different from those in Comparative Example 1 and are specifically shown in Table 1 as follows.

The rest are the same as those in Comparative Example 1, which will not be repeated herein.

TABLE 1

| | Positive electrode plate | | | | | | Negative electrode plate | | | | | |
|---|---|---|---|---|---|---|---|---|---|---|---|---|
| | | | | | | OI of | | | | | | OI of |
| | Coating 1 | | Coating 2 | | | electrode | Coating 1 | | Coating 2 | | | electrode |
| No. | D50 | OI₁ | D50 | OI₂ | OI₁/OI₂ | plate | D50 | OI₁ | D50 | OI₂ | OI₁/OI₂ | plate |
| Example 1 | 3.5 | 43.2 | 11.3 | 34.6 | 1.25 | 39.4 | 8.2 | 8.7 | / | / | / | 8.7 |
| Example 2 | 3.5 | 43.2 | 3.3 | 31.2 | 1.38 | 36.1 | 8.2 | 8.7 | / | / | / | 8.7 |
| Example 3 | 3.5 | 43.2 | 5.4 | 26.7 | 1.62 | 31.4 | 8.2 | 8.7 | / | / | / | 8.7 |
| Example 4 | 3.5 | 43.2 | 2.0 | 22.3 | 1.94 | 25.7 | 8.2 | 8.7 | / | / | / | 8.7 |
| Example 5 | 3.5 | 43.2 | 11.3 | 34.6 | 1.25 | 39.4 | 14.7 | 18.3 | / | / | / | 18.3 |
| Example 6 | 3.5 | 43.2 | 3.3 | 31.2 | 1.38 | 36.1 | 14.7 | 18.3 | / | / | / | 18.3 |
| Example 7 | 3.5 | 43.2 | 5.4 | 26.7 | 1.62 | 31.4 | 14.7 | 18.3 | / | / | / | 18.3 |
| Example 8 | 3.5 | 43.2 | 2.0 | 22.3 | 1.94 | 25.7 | 14.7 | 18.3 | / | / | / | 18.3 |
| Example 9 | 7.1 | 73.5 | 5.6 | 55.1 | 1.33 | 65.2 | 14.7 | 18.3 | / | / | / | 18.3 |
| Example 10 | 7.1 | 73.5 | 13.1 | 41.9 | 1.75 | 51.9 | 14.7 | 18.3 | / | / | / | 18.3 |
| Example 11 | 3.5 | 43.2 | / | / | / | 43.2 | 8.2 | 8.7 | 11.3 | 7.9 | 1.10 | 8.4 |
| Example 12 | 3.5 | 43.2 | / | / | / | 43.2 | 8.2 | 8.7 | 7.7 | 7.1 | 1.23 | 7.9 |
| Example 13 | 3.5 | 43.2 | / | / | / | 43.2 | 8.2 | 8.7 | 13.5 | 5.5 | 1.58 | 7.1 |
| Example 14 | 3.5 | 43.2 | / | / | / | 43.2 | 8.2 | 8.7 | 9.1 | 5.0 | 1.74 | 5.9 |
| Example 15 | 3.5 | 43.2 | / | / | / | 43.2 | 8.2 | 8.7 | 10.2 | 4.5 | 1.93 | 5.2 |
| Example 16 | 7.1 | 73.5 | / | / | / | 73.5 | 14.7 | 18.3 | 16.2 | 15.3 | 1.20 | 17.3 |
| Example 17 | 7.1 | 73.5 | / | / | / | 73.5 | 14.7 | 18.3 | 13.5 | 12.9 | 1.42 | 13.9 |
| Example 18 | 7.1 | 73.5 | / | / | / | 73.5 | 14.7 | 18.3 | 7.4 | 11.1 | 1.65 | 12.0 |
| Example 19 | 7.1 | 73.5 | / | / | / | 73.5 | 14.7 | 18.3 | 10.3 | 10.0 | 1.83 | 11.3 |
| Example 20 | 7.1 | 73.5 | / | / | / | 73.5 | 14.7 | 18.3 | 8.9 | 9.3 | 1.97 | 9.9 |
| Example 21 | 3.5 | 43.2 | 11.3 | 34.6 | 1.25 | 39.4 | 8.2 | 8.7 | 7.7 | 7.1 | 1.23 | 7.9 |
| Example 22 | 3.5 | 43.2 | 3.3 | 31.2 | 1.38 | 36.1 | 8.2 | 8.7 | 13.5 | 5.5 | 1.58 | 7.1 |
| Example 23 | 3.5 | 43.2 | 5.4 | 26.7 | 1.62 | 31.4 | 8.2 | 8.7 | 9.1 | 5.0 | 1.74 | 5.9 |
| Example 24 | 3.5 | 43.2 | 2.0 | 22.3 | 1.94 | 25.7 | 8.2 | 8.7 | 10.2 | 4.5 | 1.93 | 5.2 |
| Example 25 | 3.5 | 43.2 | 11.3 | 34.6 | 1.25 | 39.4 | 14.7 | 18.3 | 13.5 | 12.9 | 1.42 | 13.9 |
| Example 26 | 3.5 | 43.2 | 3.3 | 31.2 | 1.38 | 36.1 | 14.7 | 18.3 | 7.4 | 11.1 | 1.65 | 12.0 |
| Example 27 | 3.5 | 43.2 | 5.4 | 26.7 | 1.62 | 31.4 | 14.7 | 18.3 | 10.3 | 10.0 | 1.83 | 11.3 |
| Example 28 | 3.5 | 43.2 | 2.0 | 22.3 | 1.94 | 25.7 | 14.7 | 18.3 | 8.9 | 9.3 | 1.97 | 9.9 |
| Example 29 | 7.1 | 73.5 | 5.6 | 55.1 | 1.33 | 65.2 | 14.7 | 18.3 | 11.5 | 15.8 | 1.16 | 13.9 |
| Example 30 | 7.1 | 73.5 | 13.1 | 41.9 | 1.75 | 51.9 | 14.7 | 18.3 | 15.2 | 11.3 | 1.62 | 12.1 |
| Comparative | 3.5 | 43.2 | / | / | / | 43.2 | 8.2 | 8.7 | / | / | / | 8.7 |
| Example 1 | | | | | | | | | | | | |
| Comparative | 3.5 | 43.2 | / | / | / | 43.2 | 14.7 | 18.3 | / | / | / | 18.3 |
| Example 2 | | | | | | | | | | | | |
| Comparative | 7.1 | 73.5 | / | / | / | 73.5 | 14.7 | 18.3 | / | / | / | 18.3 |
| Example 3 | | | | | | | | | | | | |

A performance test is performed on the batteries assembled in Examples 1-30 and Comparative Examples 1-3 and includes: 1) after 5 cycles of 3C/3C charge and discharge, the battery is disassembled to confirm a lithium plating condition at an interface, and dynamic performance of the battery is determined; and 2) a 1C/1C cycle is performed at 25° C., so that cycle performance of the battery is determined. Specific test results are shown in Table 2 as follows.

TABLE 2

| | Positive electrode plate | | Negative electrode plate | | | |
|---|---|---|---|---|---|---|
| | | OI of | | OI of | | 1C/1C cycle |
| No. | OI₁/OI₂ | electrode plate | OI₁/OI₂ | electrode plate | 3C/3C lithium plating | at 25° C. |
| Example 1 | 1.25 | 39.4 | / | 8.7 | Moderate lithium plating | 1358 |
| Example 2 | 1.38 | 36.1 | / | 8.7 | Moderate lithium plating | 1672 |
| Example 3 | 1.62 | 31.4 | / | 8.7 | Moderate lithium plating | 1828 |
| Example 4 | 1.94 | 25.7 | / | 8.7 | Moderate lithium plating | 2013 |
| Example 5 | 1.25 | 39.4 | / | 18.3 | Severe lithium plating | 1293 |
| Example 6 | 1.38 | 36.1 | / | 18.3 | Severe lithium plating | 1542 |
| Example 7 | 1.62 | 31.4 | / | 18.3 | Moderate lithium plating | 1678 |
| Example 8 | 1.94 | 25.7 | / | 18.3 | Moderate lithium plating | 1989 |
| Example 9 | 1.33 | 65.2 | / | 18.3 | Severe lithium plating | 1596 |
| Example 10 | 1.75 | 51.9 | / | 18.3 | Moderate lithium plating | 2134 |
| Example 11 | / | 43.2 | 1.10 | 8.4 | Moderate lithium plating | 1732 |
| Example 12 | / | 43.2 | 1.23 | 7.9 | Slight lithium plating | 2093 |
| Example 13 | / | 43.2 | 1.58 | 7.1 | No lithium plating | 2364 |
| Example 14 | / | 43.2 | 1.74 | 5.9 | Slight lithium plating | 2131 |
| Example 15 | / | 43.2 | 1.93 | 5.2 | Slight lithium plating | 2187 |
| Example 16 | / | 73.5 | 1.20 | 17.3 | Moderate lithium plating | 1732 |
| Example 17 | / | 73.5 | 1.42 | 13.9 | Slight lithium plating | 2093 |
| Example 18 | / | 73.5 | 1.65 | 12.0 | Slight lithium plating | 2542 |
| Example 19 | / | 73.5 | 1.83 | 11.3 | Slight lithium plating | 2131 |
| Example 20 | / | 73.5 | 1.97 | 9.9 | Slight lithium plating | 2187 |
| Example 21 | 1.25 | 39.4 | 1.23 | 7.9 | Slight lithium plating | 1738 |
| Example 22 | 1.38 | 36.1 | 1.58 | 7.1 | Slight lithium plating | 2231 |
| Example 23 | 1.62 | 31.4 | 1.74 | 5.9 | No lithium plating | 2748 |
| Example 24 | 1.94 | 25.7 | 1.93 | 5.2 | No lithium plating | 2541 |
| Example 25 | 1.25 | 39.4 | 1.42 | 13.9 | Slight lithium plating | 2111 |
| Example 26 | 1.38 | 36.1 | 1.65 | 12.0 | No lithium plating | 2621 |
| Example 27 | 1.62 | 31.4 | 1.83 | 11.3 | No lithium plating | 2235 |
| Example 28 | 1.94 | 25.7 | 1.97 | 9.9 | No lithium plating | 2199 |
| Example 29 | 1.33 | 65.2 | 1.16 | 13.9 | Slight lithium plating | 1825 |
| Example 30 | 1.75 | 51.9 | 1.62 | 12.1 | Slight lithium plating | 2345 |
| Comparative | / | 43.2 | / | 8.7 | Moderate lithium plating | 1530 |
| Example 1 | | | | | | |
| Comparative | / | 43.2 | / | 18.3 | Severe lithium plating | 1210 |
| Example 2 | | | | | | |
| Comparative | / | 73.5 | / | 18.3 | Severe lithium plating | 1424 |
| Example 3 | | | | | | |

It is seen from the above test results that compared with the conventional positive electrode plate and negative electrode plate designs adopted in Comparative Examples 1-3, when the electrode plate design of the disclosure is adopted as the positive electrode plate and/or the negative electrode plate, the 3C/3C lithium plating and the cycle performance is able to be improved to a certain extent. This is mainly because the electrode plate of the disclosure divides the electrode plate coating into the two coatings for coating respectively. The Ol value of the second coating is set to be less than that of the first coating, so that an entire Ol value of the electrode plate is relatively low. Accordingly, the lithium ion transport path is shortened, the charge rate capability of the battery is improved, the cycle life of the battery is prolonged, and the safety of the battery is improved.

In addition, it is seen from the comparison between Examples 1-10 and 11-20 that when the negative electrode plate adopts the electrode plate design of the disclosure, compared with the condition that the positive electrode plate adopts the design, the battery performance is further improved. This is mainly because when the Ol value of the negative electrode plate is reduced, a path for intercalating lithium ions into the negative electrode plate is shorter and easier. However, if the mere Ol value of the positive electrode plate is reduced, although a lithium ion deintercalation path becomes shorter, an intercalation path is not changed. Comparatively, it is more difficult to perform intercalation than deintercalation. Therefore, the effects in Examples 11-20 are superior to those in Examples 1-10. Certainly, if the positive electrode plate and the negative electrode plate adopt the electrode plates of the disclosure, that is, both the lithium ion deintercalation path and the lithium ion intercalation path are shortened, the battery performance is able to be improved more significantly, and the effects in Examples 21-30 is exerted.

Further, it is also seen from the above test results that with the increase of Ol₁/Ol₂, the dynamic performance of the first coating is gradually enhanced, which effectively improves the charge rate capability and cycle capability of the battery. However, if Ol₁/Ol₂ is excessively great, owing to a great difference in lithium intercalation capability between the first coating and the second coating, poor consistency and local deterioration of the electrode plate will be caused, so that lithium plating during charge and the cycle capability are reduced. Accordingly, Ol₁/Ol₂ preferably satisfies the relational expression 1.1≤Ol₁/Ol₂≤2.0. In the interval, by adjusting Ol₁/Ol₂ of the positive electrode plate and the negative electrode plate, the battery performance is able to be improved more significantly.

In conclusion, the electrode plate provided by the disclosure solves the problem that since a coating weight and a coating thickness designed for an electrode plate keeps increasing, a charge transfer path becomes longer. Accordingly, the charge rate capability of the battery is improved, the cycle life of the battery is prolonged, and the safety of the battery is improved.

Those skilled in the art can also make variations and modifications to the above embodiments according to the disclosure and teachings of the above description. Therefore, the disclosure is not limited to the above particular embodiments, and any obvious improvement, substitution, or variation made by those skilled in the art on the basis of the disclosure should fall within the scope of protection of the disclosure. In addition, while some specific terms are used in the description, these terms are merely for the sake of description and are not intended to limit the disclosure.

What is claimed is:

1. An electrode plate, comprising:
a current collector;
a first coating, the first coating is coated on at least one surface of the current collector; and
a second coating, the second coating is coated on a surface of the first coating away from the current collector;
an Ol value of the second coating is less than an Ol value of the first coating.

2. The electrode plate according to claim 1, wherein the Ol value of the first coating represented by Ol₁ and the Ol value of the second coating represented by Ol₂ satisfy a relational expression: 1.1≤Ol₁/Ol₂≤2.0.

3. The electrode plate according to claim 2, wherein the Ol value of the first coating represented by Ol₁ is 5-80, and the Ol value of the second coating represented by Ol₂ is 3-40.

4. The electrode plate according to claim 3, wherein an Ol value of an active material in the first coating is 2.5-20, and an Ol value of an active material in the second coating is 2-15.

5. The electrode plate according to claims 2-4, wherein the resistance of an active material in the first coating is 1Ω-30Ω, and the resistance of an active material in the second coating is 0.3Ω-10Ω.

6. The electrode plate according to claims 2-4, wherein an average particle diameter D50 of an active material in the first coating is 2 μm-30 μm, and an average particle diameter D50 of an active material in the second coating is 1 μm-20 μm.

7. The electrode plate according to claims 2-4, wherein the specific surface area of an active material in the first coating is 0.2 m²/g-2.0 m²/g, and the specific surface area of an active material in the second coating is 0.5 m²/g-3.0 m²/g.

8. The electrode plate according to claim 1, wherein the thickness of the second coating is less than the thickness of the first coating.

9. The electrode plate according to claim 8, wherein the thickness of the first coating represented by H1 and the thickness of the second coating represented by H2 satisfy a relational expression: 1<H₁/H₂<10.

10. The electrode plate according to claim 9, wherein the H₁ is 50 μm-300 μm, and the H₂ is 10 μm-200 μm.

11. A battery, comprising a positive electrode plate, a negative electrode plate, and a separator spacing the positive electrode plate and the negative electrode plate apart, and the positive electrode plate and the negative electrode plate are the electrode plate according to claims 1-10, or the positive electrode plate or the negative electrode plate is the electrode plate according to any one of claims 1-10.

12. The battery according to claim 11, wherein the Ol value of the first coating represented by Ol₁ and the Ol value of the second coating represented by Ol₂ satisfy a relational expression: 1.1≤Ol₁/Ol₂≤2.0.

13. The battery according to claim 12, wherein the Ol value of the first coating represented by Ol₁ is 5-80, and the Ol value of the second coating represented by Ol₂ is 3-40.

14. The battery according to claim 13, wherein an Ol value of an active material in the first coating is 2.5-20, and an Ol value of an active material in the second coating is 2-15.

15. The battery according to claim 12, wherein the resistance of an active material in the first coating is 1Ω-30Ω, and the resistance of an active material in the second coating is 0.3Ω-10Ω.

16. The battery according to claim 12, wherein an average particle diameter D50 of an active material in the first coating is 2 μm-30 μm, and an average particle diameter D50 of an active material in the second coating is 1 μm-20 μm.

17. The battery according to claim 12, wherein the specific surface area of an active material in the first coating is 0.2 m²/g-2.0 m²/g, and the specific surface area of an active material in the second coating is 0.5 m²/g-3.0 m²/g.

18. The battery according to claim 11, wherein the thickness of the second coating is less than the thickness of the first coating.

19. The battery according to claim 18, wherein the thickness of the first coating represented by H₁ and the thickness of the second coating represented by H2 satisfy a relational expression: 1<H₁/H₂<10.

20. The battery according to claim 19, wherein the H₁ is 50 μm-300 μm, and the H₂ is 10 μm-200 μm.
